(19) United States
(12) Patent Application Publication
(10) Pub. No.: US 2026/0105727 A1
(43) Pub. Date: Apr. 16, 2026

(54) TRAINING A COMPUTER VISION MODEL TO CLASSIFY HEALTH TEST KIT RESULTS

(71) Applicant: SAFE HEALTH SYSTEMS, INC., Queen Creek, AZ (US)

(72) Inventors: Irina Kolomiets, Marietta, GA (US); Darrell Ingram, Galisteo, NM (US)

(21) Appl. No.: 18/912,135

(22) Filed: Oct. 10, 2024

(51) Int. Cl. G06V 10/774; G06V 10/42; G06V 10/44; G06V 10/764; G06V 10/77; G06V 10/776; G06V 10/80; G06V 10/82

(52) U.S. Cl. CPC G06V 10/774; G06V 10/42; G06V 10/44; G06V 10/764; G06V 10/7715; G06V 10/776; G06V 10/806; G06V 10/82; G06V 2201/03

(57) ABSTRACT

To train a computer vision model to classify health test kit results, a computing system obtains a plurality of training images. Each training image depicts a plurality of health test results in respective segments of a test membrane of a health test kit. The computing system obtains, for each training image, labeling indicating the health test results depicted by the training image. The computing system trains a plurality of local Convolutional Neural Networks (CNNs) of the computer vision model in parallel. Each of the local CNNs is trained to predict the health test result depicted in a respective one of the segments based on local features extracted by the local CNN from the respective one of the segments of each training image and global features extracted by a global CNN of the computer vision model from the test membrane of each training image.

### BACKGROUND

A health test kit (e.g., a COVID-19 test, a pregnancy test) typically includes a window in which test results (e.g., positive, negative) are shown. The window may, for example, enclose fluid that surrounds a membrane of chemically reactive material that changes color in the presence of a pathogen, antibody, or enzyme of interest.

Test results depicted by a test kit may be difficult to decipher for several reasons. For example, test results may be faint, the fluid chamber may include trapped bubbles or other floating material, shadows or glare may affect result appearance, coloration may be difficult discern, and the like. The more complex the results, the more likely it is that the results will be misinterpreted. This is particularly true for test kits that provide multiple test results that are tightly grouped within the same test result window. In such cases, there is the added risk of a given result being attributed to the wrong diagnostic test, for example.

### BRIEF SUMMARY

Embodiments of the present disclosure generally relate to computer vision model training and, more particularly, to techniques and systems for training a computer vision model to classify health test kit results. Particular embodiments recognize that it would be advantageous for computers to assist in interpreting test kit results, e.g., to reduce errors made by laypersons (e.g., patients, consumers). In this regard, one or more Artificial Intelligence (AI) computer vision techniques described herein may be useful as a substitute for, or supplement to, human judgment. Although computers are already generally capable of correctly identifying the results of simple, single result tests, health kits that provide more than one test result present a unique challenge that conventional solutions are ill-equipped to address. This is particularly true when the result results are tightly clustered on the same test membrane.

In view of the above, one or more embodiments include a method, implemented by a computing system, of training a computer vision model to classify health test kit results. The method comprises obtaining a plurality of training images. Each training image depicts a plurality of health test results in respective segments of a test membrane of a health test kit. The method further comprises obtaining, for each training image, labeling indicating the health test results depicted by the training image. The method further comprises training a plurality of local Convolutional Neural Networks (CNNs) of the computer vision model in parallel. The training comprises, for each of the local CNNs, predicting the health test result depicted in a respective one of the segments of each training image based on local features extracted by the local CNN from the respective one of the segments of the training image, and global features extracted by a global CNN of the computer vision model from the test membrane of the training image.

In some embodiments, training the plurality of local CNNs comprises, for each of the training images, generating, by the global CNN, a global feature map indicating the global features extracted from the training image. Training the plurality of local CNNs further comprises, for each segment of the test membrane of the training image, using the local CNN corresponding to the segment to generate a local feature map indicating the local features extracted from the segment. Training the plurality of local CNNs further comprises, for each segment of the test membrane of the training image, using the local CNN corresponding to the segment to generate a combined feature map by combining the local feature map with the global feature map. Training the plurality of local CNNs further comprises, for each segment of the test membrane of the training image, using the local CNN corresponding to the segment to extract combined features from the combined feature map and generate a revised local feature map indicating the combined features extracted from the combined feature map. Predicting the health test result depicted in the segment based on the local features and the global features comprises using the revised local feature map to generate a prediction based on the combined features.

In some embodiments, training the plurality of local CNNs further comprises, for each of the training images, applying a loss function to determine an amount of error between the predictions of the heath test results depicted in the segments of the training image and the labeling of the training image.

In some embodiments, using the local CNN of each segment to generate the prediction of the health test result depicted in the segment comprises using a binary classifier of the local CNN to generate the prediction. Using the local CNN of each segment to generate the prediction of the health test result depicted in the segment further comprises training the plurality of local CNNs further comprises adjusting each of the binary classifiers to reduce the amount of error using a gradient calculated by backpropagating the loss function.

In some embodiments, the loss function comprises a cross-entropy loss function. Backpropagating the loss function comprises adjusting weights applied by each of the binary classifiers to generate the predictions.

In some embodiments, the method further comprises obtaining a non-training image depicting a plurality of actual health test results in the respective segments of the test membrane of the health test kit. The method further comprises using the global CNN and the trained local CNNs of the computer vision model to determine whether each of the actual health test results indicates a positive or negative result.

In some embodiments, the method further comprises further training at least one of the local CNNs responsive to receiving result labels indicating each of the actual health test results depicted by the non-training image.

In some embodiments, the method further comprises detecting the segments of each training image. The segments of each training image are arranged in a single row.

In some embodiments, the method further comprises detecting the segments of each training image. The segments of each training image are arranged in a two-dimensional grid.

Other embodiments are directed to a computing system. The computing system comprises processing circuitry and memory circuitry. The memory circuitry stores instructions executable by the processing circuitry whereby the computing system is configured to obtain a plurality of training images. Each training image depicts a plurality of health test results in respective segments of a test membrane of a health test kit. The computing system is further configured to obtain, for each training image, labeling indicating the health test results depicted by the training image. The computing system is further configured to train a plurality of local Convolutional Neural Networks (CNNs) of the computer vision model in parallel. To train the plurality of local CNNs the computing system is configured to predict, for each of the local CNNs, the health test result depicted in a respective one of the segments of each training image based on local features extracted by the local CNN from the respective one of the segments of the training image, and global features extracted by a global CNN of the computer vision model from the test membrane of the training image.

In some embodiments, to train the plurality of local CNNs the computing system is configured to, for each of the training images, use the global CNN to generate a global feature map indicating the global features extracted from the training image. To train the plurality of local CNNs the computing system is further configured to, for each segment of the test membrane of the training image, use the local CNN corresponding to the segment to generate a local feature map indicating the local features extracted from the segment. To train the plurality of local CNNs the computing system is further configured to, for each segment of the test membrane of the training image generate a combined feature map by combining the local feature map with the global feature map. To train the plurality of local CNNs the computing system is further configured to, for each segment of the test membrane of the training image, extract combined features from the combined feature map and generate a revised local feature map indicating the combined features extracted from the combined feature map. To predict the health test result depicted in the segment based on the local features and the global features the computing system is configured to use the revised local feature map to generate a prediction based on the combined features.

In some embodiments, to train the plurality of local CNNs the computing system is further configured to, for each of the training images, apply a loss function to determine an amount of error between the predictions of the heath test results depicted in the segments of the training image and the labeling of the training image.

In some embodiments, to use the local CNN of each segment to generate the prediction of the health test result depicted in the segment the computing system is configured to use a binary classifier of the local CNN to generate the prediction. To train the plurality of local CNNs the computing system is further configured to adjust each of the binary classifiers to reduce the amount of error using a gradient calculated by backpropagating the loss function.

In some embodiments, the loss function comprises a cross-entropy loss function. To backpropagate the loss function the computing system is configured to adjust weights applied by each of the binary classifiers to generate the predictions.

In some embodiments, the computing system is further configured to obtain a non-training image depicting a plurality of actual health test results in the respective segments of the test membrane of the health test kit. The computing system is further configured to use the global CNN and the trained local CNNs of the computer vision model to determine whether each of the actual health test results indicates a positive or negative result.

In some embodiments, the computing system is further configured to train at least one of the local CNNs responsive to receiving result labels indicating each of the actual health test results depicted by the non-training image.

In some embodiments, the computing system is further configured to detect the segments of each training image. The segments of each training image are arranged in a single row.

In some embodiments, the computing system is further configured to detect the segments of each training image. The segments of each training image are arranged in a two-dimensional grid.

Other embodiments include a non-transitory, computer readable medium storing software instructions for controlling a programmable computing system to train a computer vision model. The software instructions, when executed by processing circuitry of the programmable computing system, cause the programmable computing system to obtain a plurality of training images. Each training image depicts a plurality of health test results in respective segments of a test membrane of a health test kit. The programmable computing system is further caused to obtain, for each training image, labeling indicating the health test results depicted by the training image. The programmable computing system is further caused to train a plurality of local Convolutional Neural Networks (CNNs) of the computer vision model in parallel. The training comprises, for each of the local CNNs, predicting the health test result depicted in a respective one of the segments of each training image based on local features extracted by the local CNN from the respective one of the segments of the training image and global features extracted by a global CNN of the computer vision model from the test membrane of the training image.

Of course, those skilled in the art will appreciate that the present embodiments are not limited to the above contexts or examples and will recognize additional features and advantages upon reading the following detailed description and upon viewing the accompanying drawings.

### BRIEF DESCRIPTION OF THE DRAWINGS

Aspects of the present disclosure are illustrated by way of example and are not limited by the accompanying figures with like references indicating like elements. In general, the use of a reference numeral should be regarded as referring to the depicted subject matter according to one or more embodiments, whereas discussion of a specific instance of an illustrated element will append a letter designation thereto (e.g., discussion of a health test kit 200, generally, as opposed to discussion of particular instances of health test kits 200a, 200b).

FIGS. 1A-C are schematic diagrams illustrating different examples of health test kits according to one or more embodiments of the present disclosure.

FIG. 2 is a logical block diagram illustrating an example process for training a computer vision model 300 according to one or more embodiments of the present disclosure.

FIG. 3 is a logical block diagram illustrating an example of interaction between a global CNN, a local CNN, and a loss function according to one or more embodiments of the present disclosure.

FIG. 4 is a logical block diagram illustrating an example of feature extraction according to one or more embodiments of the present disclosure.

FIG. 5 is a flow diagram illustrating an example computer vision-based health diagnosis procedure implemented by a computing system according to one or more embodiments of the present disclosure.

FIG. 6 is a flow diagram illustrating an example method implemented by a computing system according to one or more embodiments of the present disclosure.

FIG. 7 is a schematic block diagram illustrating an example computing system according to one or more embodiments of the present disclosure.

### DETAILED DESCRIPTION

The decentralization of diagnostic testing has the potential to significantly increase access and decrease the cost of routine medical care. Although traditional rapid lateral flow tests provide lay people with the ability to self-test at home, interpretation of the test result is traditionally highly subjective and, to date, has been untethered to public health reporting systems. Implementation of a computer vision-based solution for interpreting the test results produced by health test kits would greatly contribute to the public good by providing a number of critical public health benefits.

For example, digital interpretation of visually read tests may be advantageous over traditional methods by removing subjectivity from test interpretation, which in turn may reduce the risk of inaccurate result reporting. Embodiments may additionally or alternatively reduce inaccuracies by eliminating the requirement for self-attestation of test results. In this regard, public health reporting may be enhanced by improving the quality of data reported at a state and federal level. Moreover, storing the test image and result of reported tests may allow for improved traceability. Implementation of a software platform that provides clear instructions on the use of a test, paired with an AI-enabled computer vision interpretation and, in some embodiments, automated test result reporting is expected to greatly improve the implementation of at home, or Point of Need (PON) testing. Greater situational awareness of disease prevalence may also be provided to public health agencies.

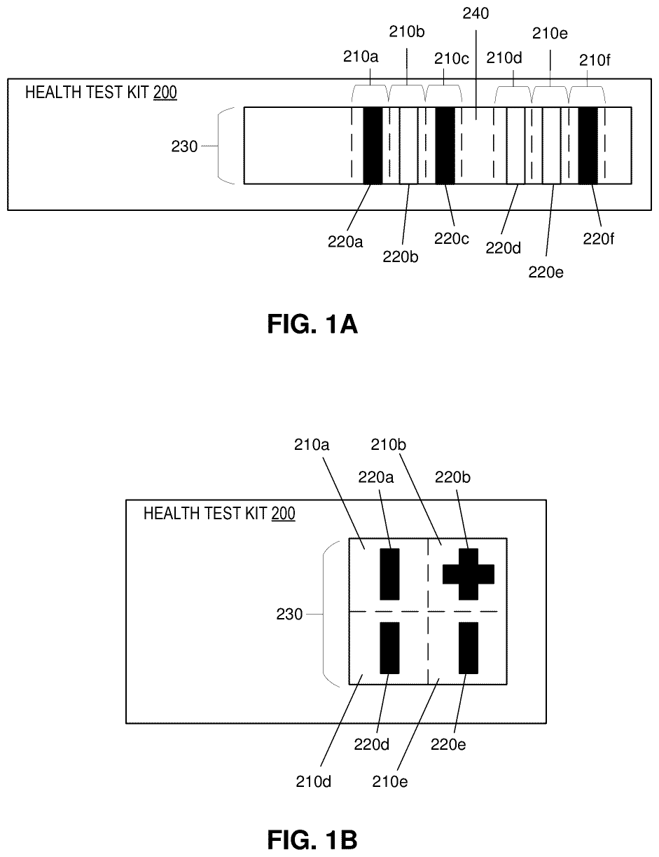

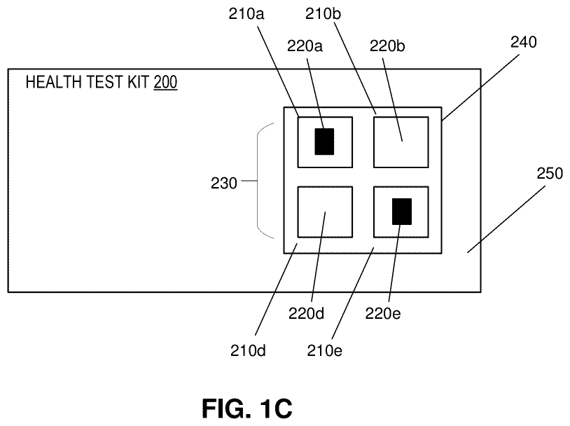

Heath test kits may take a variety of forms. FIG. 1A is a schematic block diagram illustrating an example health test kit 200. The health test kit 200 comprises a test membrane 230. The test membrane 230 comprises a plurality of segments 210a-f. In this particular example, the test membrane 230 comprises six segments 210a-f. Each of the segments 210a-f depicts a respective health test result 220a-f.

In the example of FIG. 1A, the segments 210a-f of the test membrane 230 are arranged in a single row. In this example, segment 210b is adjacent to each of segments 210a and 210c. Segment 210e is adjacent to segments 210d and segment 210f. However, in this example, segments 210c and 210d are separated by an empty space 240 that is not attributable to any segment 210. That is, no health test result 220 is associated with the empty space 240. Each health test result 220 may be dark or light depending on whether a test associated with the corresponding segment 210 returns a positive or negative result, respectively.

In the example of FIG. 1B, the test membrane 230 is arranged in a two-dimensional grid. More specifically, in FIG. 1B, the test membrane 230 comprises four segments 210a-d arranged in a contiguous 2×2 grid. In this example, each health test result 220 may be a plus sign or a minus sign depending on whether a test associated with the corresponding segment 210 returns a positive or negative result, respectively.

Generally speaking, a health test kit 200 may comprise any number of segments 210 depending on the embodiment. Each segment depicts a respective health test result 220. Typically, the health test result 220 depicted will depend on how a reactive material within the corresponding segment 210 reacts to a material of interest. For example, the membrane 230 at a given segment 210a may turn a different color in the presence of a particular pathogen, antibody, or enzyme of interest and respond differently or remain unchanged otherwise. The different health test results 220 that may be depicted within a particular segment 210 may be based on color, shape, and/or size, for example.

The segments 210 may be arranged in any way that fits on the health test kit 200 depending on the embodiment. One, some, or all of the segments 210 may be adjacent in some embodiments whereas in other embodiments one, some, or all of the segments may be separated by an empty space 240. In some embodiments, the health test kit 200 may comprise a housing and the test membrane 230 may be visible through a window 240 in the housing 250, as shown in the example of FIG. 1C. In this particular example, each of the segments 210a-d is viewable through a respective pane of the window 240. In other embodiments, the window 240 may comprise a different number of panes (e.g., one) through which more than one segment (e.g., all the segments) is viewable.

It should also be appreciated that some embodiments may include one or more control results. A control result may be used as a representation of an actual health test result 210 for use as a reference. For example, users may be instructed that a given location on the test membrane 230 includes a control result depicting a positive test result (e.g., a plus sign in the example of FIG. 1B). Users would then look for a similar shape elsewhere on the test membrane 230 to determine whether the health test kit 200 has detected any actual positive test results.

Due to the wide variability in how different health test kits 200 may arrange and depict test results 220, each health test kit 200 can present a unique interpretation challenge. In view of this variability, embodiments of the present disclosure may use a comprehensive image set as a foundation for training a Computer Vision Machine Learning (CVML) algorithm to learn how to classify the health test results 220 depicted by a health test kit 200. Once the model is trained and validated, the model may (for example) be used in analytical and clinical validation studies. The data produced by the model during such studies may be submitted to the Food and Drug Administration (FDA) to add the digital reading and public health reporting capabilities to FDA applications for PON tests.

To create a representative image dataset, a health test kit 200 to be learned by the computer vision model is placed under a variety of conditions that simulate what the model is likely to encounter in the real world. A plurality of images of the health test kit 200 are then captured under these conditions. A variety of different results are also captured under a variety of conditions. Generally speaking, the greater the number of representative images in the dataset, the more accurate the model will be in classifying actual health test results 210. As such, images may be captured using a variety of techniques under a variety of conditions using a variety of devices. For example, images may be captured using different cameras running different software (e.g., iOS and Android operating systems) images under different lighting conditions with the health test kit 200 in different orientations, elevations relative to the kit 200 against different backgrounds at different amounts of blur or any combination thereof. For superior training results, it is recommended that more than 2000 images be used to train the model for each health test kit 200 to be learned.

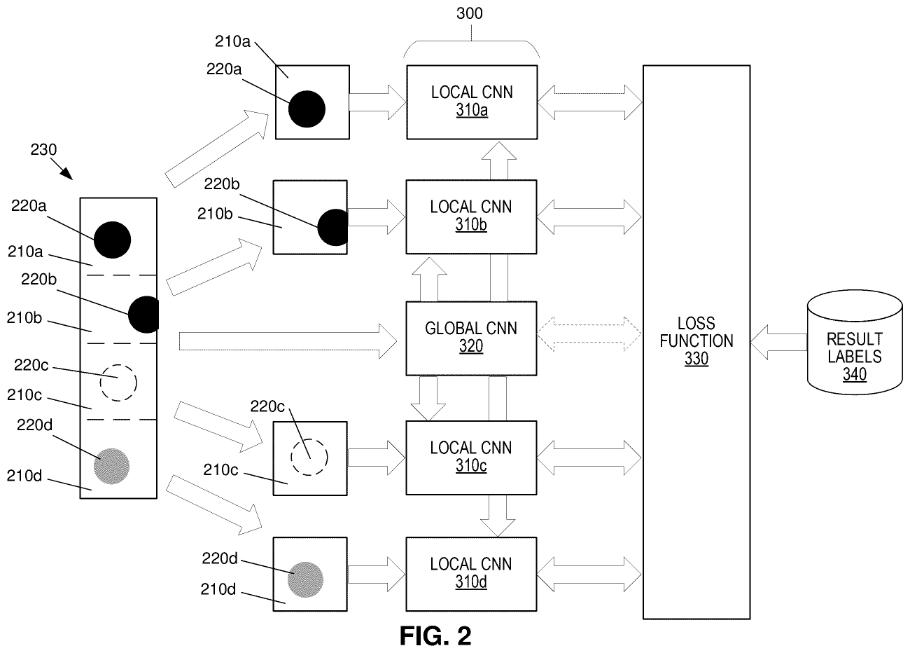

FIG. 2 is a block diagram illustrating an example process for training a computer vision model 300 according to one or more embodiments of the present disclosure. In this example, a test membrane 230 comprising four segments 210a-d is used to train the model 300. Each of the segments 210 reflects either a positive test result (in this example, test results 220a, 220b, 220d) or a negative test result (in this example, test result 220c). A positive test result is depicted by a darkened circle. As shown in the example of FIG. 2, a circle may have varying degrees of darkness, may be off-center, or may have other irregularities that may frustrate interpretation.

The model 300 comprises a global Convolutional Neural Network (CNN) 320 and a plurality of local CNNs 310a-d. One or more of the CNNs 310, 320 may comprise, e.g., a residual neural network (ResNet).

In this example, the model 300 comprises as many local CNNs 310a-d as there are segments 210a-d, such that each segment 210 corresponds to a respective local CNN 310. Each of the CNNs 310a-d, 320 performs feature extraction upon their respective inputs to generate a respective feature map. The global CNN 320 performs feature extraction on the overall test membrane 230, whereas each of the local CNNs 310a-d performs feature extraction on a respective one of the segments 210a-d. The global CNN 320 then provides input to each of the local CNNs 310a-d so that global features may be accounted for when performing local feature extraction.

Each of the local CNNs 310a-d generates a classification result and a corresponding confidence score based on the local and global extracted features. For example, local CNN 310a may predict a positive result with 90% confidence for segment 220a (e.g., given that corresponding segment 220a is dark, clear, and centered) whereas local CNN 310b may predict a positive result with only 80% confidence for segment 220b (e.g., given that corresponding segment 220b is dark and clear, but off-center and slightly truncated).

The classification results and corresponding confidence scores generated by the local CNNs 310a-d are provided to a loss function 330. The loss function 330 uses the classification results, the confidence scores, and result labels 340 indicating the actual test results 220a-d of segments 210a-d to determine how well each of the local CNNs 310a-d is at classifying the test results 220a-d and to provide feedback to the local CNNs 310a-d accordingly. Through this feedback, the loss function 330 reinforces classification when predictions are made accurately and improves classification when predictions are made inaccurately.

It should be noted that, in some embodiments, the loss function 330 also obtains results from and/or provides feedback to the global CNN 320.

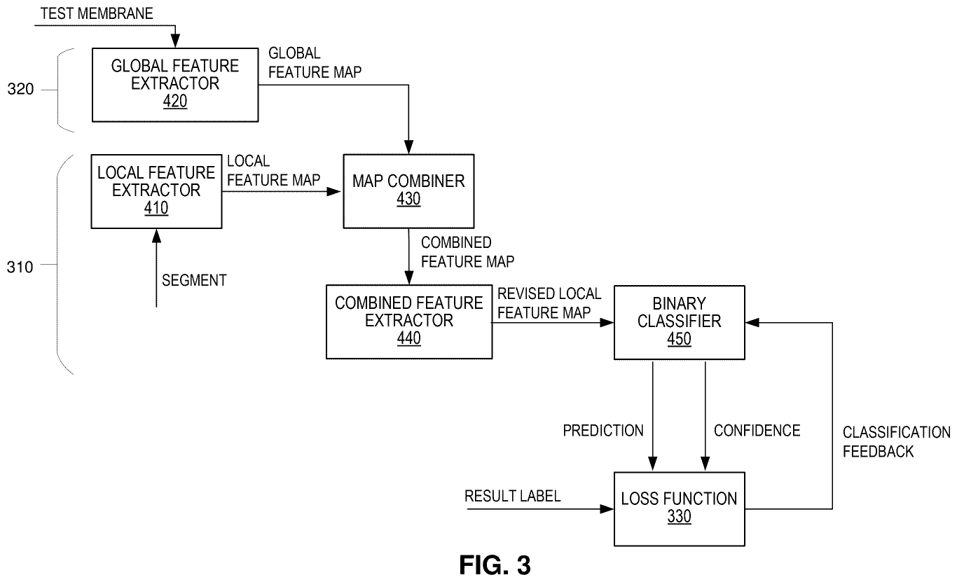

FIG. 3 illustrates an example of interaction between the global CNN 320, a local CNN 310, and the loss function 330. In some embodiments, each of the local CNNs 310 interacts with the global CNN 320 and the loss function 330 in this manner. As shown in FIG. 3, the global CNN 320 comprises a global feature extractor 420 that accepts a test membrane 230 as input. The global feature extractor 420 extracts features of the overall test membrane 230 to generate a global feature map. In this way, features that may be relevant to more than one of the segments 210a-d (e.g., glare) may be captured and accounted for in the image analysis. The global feature extractor 420 provides the global feature map to the local CNN 310.

The local CNN 310 comprises a local feature extractor 410, a map combiner 430, a combined feature extractor 440, and a binary classifier 450. The local feature extractor 410 accepts a segment 210 of the test membrane 230 as input. The local feature extractor 410 extracts features that are particular to the segment 210 to generate a local feature map. The global feature map and local feature map are combined by the map combiner 430 to generate a combined feature map. The combined feature extractor 440 extracts features from the combined feature map to generate a revised local feature map. In this way, a feature map is generated that is influenced by both global and local features, each grouping of features being independently tunable by providing feedback to either the global CNN, the local CNN, or respective feedback to each.

The binary classifier 450 accepts the revised local feature map as input and makes a prediction of the health test result 220 depicted by the segment 210. The binary classifier 450 provides this prediction, along with a confidence in the prediction, to the loss function 330. The loss function 330 uses the prediction, the confidence, and a result label indicating the health test result 220 depicted by the segment 210 to generate classification feedback. The loss function 330 provides this classification feedback to the binary classifier 450 to improve future predictions.

For example, the binary classifier 450 may make a prediction by generating a score between zero and one. The closer the score is to zero, the more confident the binary classifier 450 is that the test result 220 is negative. Correspondingly, the closer the score is to one, the more confident the binary classifier 450 is that the test result 220 is positive. In this regard, the binary classifier 450 may apply one or more weights that, when applied to a given feature map, tend to influence the classification result towards a zero or a one. The classification feedback may comprise an adjustment to one or more of these weights.

Additionally or alternatively, the binary classifier 450 may apply a positive threshold and a negative threshold to make a prediction. For example, if the binary classifier 450 generates a score that is above the positive threshold, the binary classifier 450 makes a positive prediction. Correspondingly, if the binary classifier 450 generates a score that is below the negative threshold, the binary classifier 450 makes a negative prediction. If the binary classifier 450 generates a score that is in between the positive threshold and the negative threshold, the binary classifier 450 may indicate that it is unable to make a prediction. For example, the segment 220 may be too blurry or include too much glare to discern a result. In some embodiments, the classification feedback comprises an adjustment to one or more of these thresholds.

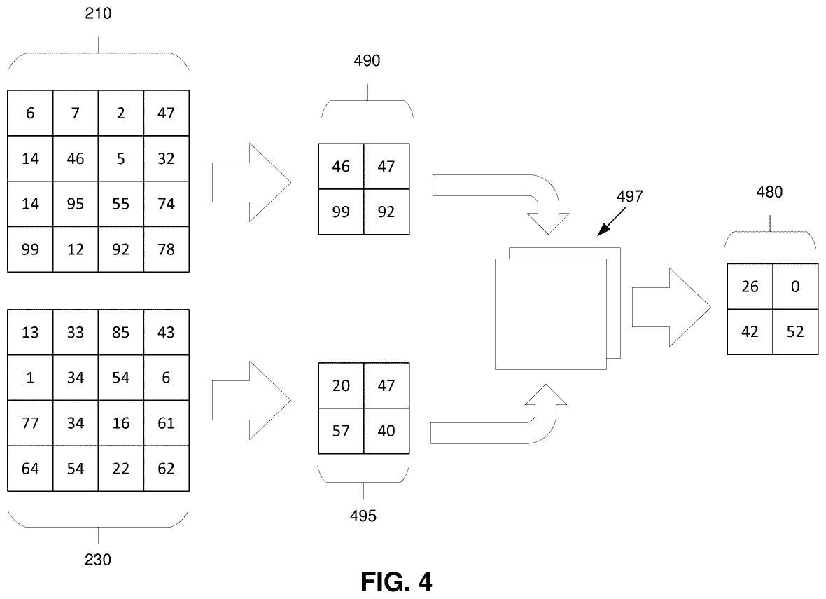

FIG. 4 illustrates an example of feature extraction according to one or more embodiments of the present disclosure. Feature extraction is a process in which information of interest about an image or feature map is extracted using a corresponding process. In this example, a feature of interest regarding segment 210 is extracted to produce a local feature map 490. A feature of interest regarding test membrane 230 is extracted to produce a global feature map 495. The local feature map 490 and the global feature map 495 are combined to form a combined feature map 497. In this example the feature maps 490, 495 are combined in a way that results in a combined feature map 497 having greater dimensionality than the local and global feature maps 490, 495, individually. However, it should be understood that the local and global feature maps 490, 495 may be combined in a variety of ways, e.g., depending on the particular features being extracted, the manner in which the combined feature map 497 will be further processed, and so on.

The segment 210 comprises a pixel grid. Each grid location in this example comprises a darkness value. In this example, local feature extraction involves generating a local feature map 490 by extracting the darkest pixel value at each non-overlapping 2×2 area of the segment 210. The darkest pixel in the upper-leftmost 2×2 area of the segment 210 in this example is 46. The darkest pixel in the upper-rightmost 2×2 area of the segment 210 in this example is 47. The darkest pixel in the lower-leftmost 2×2 area of the segment 210 in this example is 99. The darkest pixel in the lower-rightmost 2×2 area of the segment 210 in this example is 92. This analysis may, e.g., reflect that the lower half of the segment 210 is substantially darker than the upper half of the segment 210.

Although this example produces a single layer feature map 490, it should be noted that a feature map 490, 495 may have any number of layers. For example, a multiple-layer feature map may be used when multiple features are extracted, each feature corresponding to a respective layer (e.g., respective layers for contrast, saturation, and hue). The layers may, but need not, be the same size.

The test membrane 230 also comprises a pixel grid. Each grid location of the test membrane 230 in this example represents blue saturation and global feature extraction comprises generating a global feature map 495 by averaging the pixel values at each non-overlapping 2×2 area of the test membrane 210. Although the size of the test membrane grid is depicted in FIG. 4 to be the same size as the grid of the segment 210, this is a simplification solely for purposes of explanation. It will be appreciated that the pixel grid of the test membrane 230 will be larger than that of its segments 210.

The local feature map 490 and the global feature map 495 are combined to form a combined feature map 497. Feature extraction is then performed on the combined feature map 497 to generate a revised local feature map 480 that will be used by the binary classifier 450 may make a classification decision. For example, the feature extraction performed on the combined feature map 497 may extract features regarding how the local and global features relate to each other (e.g., the difference between a local darkness value relative to the average darkness of the larger area of the test membrane 230).

In this way, the binary classifier 450 may, e.g., classify a segment as indicating a positive result if the local darkness is substantially darker than the global darkness. In this regard, the bigger the difference between the local and global darknesses, the more confident the binary classifier 450 may be in its determination, for example.

The binary classifier 450 may weigh each of any one or more of the features represented in the revised local feature map 480 to a different degree. The different weights that are applied to each of the features considered may be tuned by the feedback provided by the loss function 330 described above. The training procedure may accommodate a variety of loss functions 330, depending on the embodiment (e.g., mean squared error, cross-entropy, mean absolute percentage error).

It should be noted that the above analysis is a very basic example for purposes of explanation. Embodiments of the present disclosure may consider any one or more local features represented in each local feature map 490 in any combination with any one or more global features represented in the global feature map 495. The feature extraction appropriate for the combined feature map 497 may depend on the features represented in local and global feature maps 490, 495, the manner in which the local and global features maps 490, 495 are combined, the shape and design of the health test kit 200 being learned, and/or other factors beyond the scope of this disclosure.

The training process is generally performed repeatedly for a large number of training images, each training image resulting in feedback from the loss function 330 used to tune the binary classifiers 450 of each respective local CNN 310. After training, the computer vision model 300 may be used to accurately and reliably identify actual test results 220 indicated by images of the health test kit 200 taken by actual users who wish to receive an automated health diagnosis.

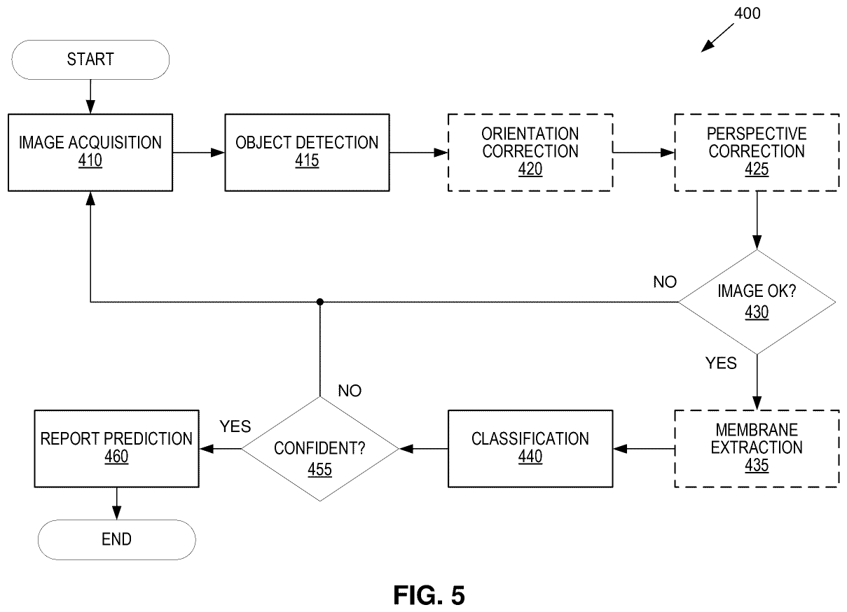

Consistent with the above, FIG. 5 is a flow chart of an example computer vision-based health diagnosis procedure 400 implemented by a computing system according to one or more embodiments of the present disclosure. To begin, the computing system obtains an image of a health test kit 200, e.g., using a camera or uploaded from another device (block 410). The computing system performs object detection to recognize the health test kit 200 within the image, e.g., to determine that the test membrane 230 is in frame (block 415).

The computing system may then perform orientation correction on the image, e.g., to ensure that the segments 210 appearing in the image are in the correct orientation for processing by the appropriate corresponding local CNN 310 (block 420). For example, if the image of the test membrane 230 is upside down and orientation correction is not performed, the CNN 310 trained to classify the topmost segment could improperly be applied to the bottommost segment. As such, orientation correction 420 may rotate the image until the segments 210 are in an intended orientation. That said, orientation correction may not be necessary, e.g., if the image is already in the correct orientation upon acquisition.

After orientation correction, the computing system may perform perspective correction, e.g., to adjust for forward or backward tilt of the test membrane 230 (block 425). That said, perspective correction may not be necessary, e.g., if the image was taken from an angle substantially perpendicular to the surface of the test membrane 230 such that the test membrane 230 does not appear to be tilted.

The computing system determines whether the image is suitable for classification (block 430). The image may be deemed unsuitable if, for example, the test membrane 230 could not be detected or if appropriate orientation and/or perspective corrections could not successfully be applied in previous steps. If the image is determined to be unsuitable, the computing system may return to the image acquisition step to acquire a substitute image (block 430, no path). Alternatively, the procedure 400 may end (not shown).

If the image is determined to be suitable for classification (block 430, yes path), the computing system may perform membrane extraction (step 435). During membrane extraction, the portion of the image pertaining to the test membrane 230 may be cropped out of the surrounding image. That said, membrane extraction may not be necessary, e.g., if the image was taken from a sufficiently close distance that the area surrounding the test membrane 230 is out of frame.

The computing device then uses the trained model 300 to perform classification on the image (block 440). The classification performed in this step is similar to that performed during training as previously described with reference to FIGS. 2 and 3. During classification, the model 300 uses a global CNN 320 to extract global features of the test membrane 230 and a plurality of local CNNs 310 to extract local features particular to respective segments 210 of the test membrane 230. Classification during the diagnosis procedure 400 differs from the training process however, in that the test membrane 230 is unlabeled. That is, the actual test results 220 indicated by the test membrane 230 may not yet be known. As such, no record corresponding to the test membrane 230 being analyzed may be available in the result labels 340 used during training. As such, functions of the loss function 330 to compare the classification prediction to an intended or expected result and provide feedback to the binary classifiers 450 of the local CNNs 310 may be omitted.

Alternatively, application of the loss function 330 to the image may be deferred until result labels 340 corresponding to the image are subsequently provided to the computing system. In this regard, the computer vision model 300 may, in some embodiments, continue to train and improve using the health kit images provided by users to obtain a diagnosis.

As previously noted, each of the binary classifiers 450 generate a prediction and a confidence score. Accordingly, the computing system determines whether the confidence scores exceed a confidence threshold (block 455). If one or more of the predictions corresponds to a confidence score that is insufficient (block 455, no path), the computing device may, in some embodiments, return to the image acquisition stage to obtain a new image for evaluation. If one or more of the predictions corresponds to a confidence score that is sufficient (block 455, yes path), the computing system may report those prediction(s) to the user (e.g., on a display or by electronic message) (block 460).

In some embodiments, the computing system may classify one or more test results 220 with high confidence and one or more test results 220 with low confidence. In such embodiments, the computing system may report the high confidence prediction(s) and refrain from reporting the low confidence prediction(s). Alternatively, the computing device may require that more than a threshold number of the predictions have high confidence in order to report.

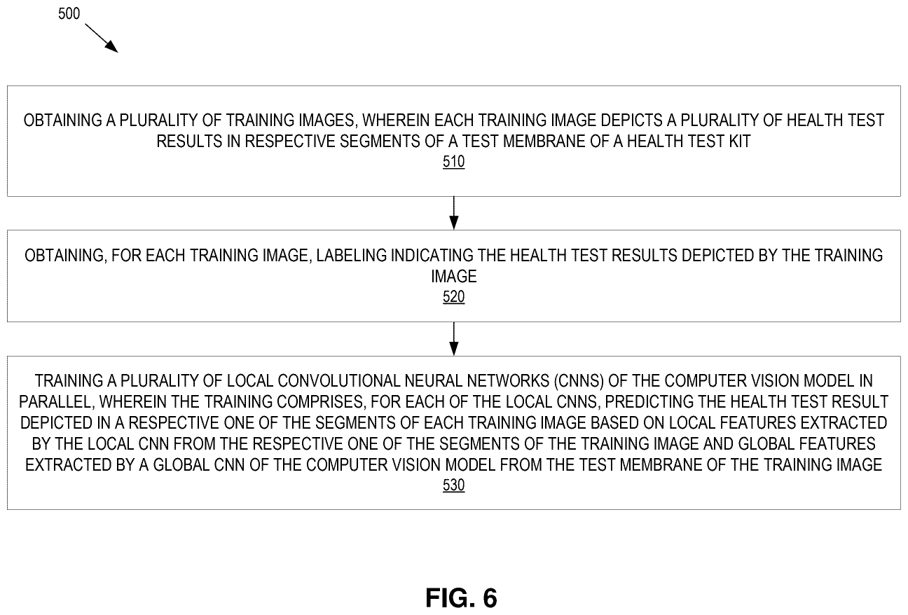

In view of the above, embodiments of the present disclosure include a method 500 of training a computer vision model to classify health test kit results, e.g., as shown in FIG. 6. The method is implemented by a computing system and comprises obtaining a plurality of training images (block 510). Each training image depicts a plurality of health test results in respective segments of a test membrane of a health test kit. The method further comprises obtaining, for each training image, labeling indicating the health test results depicted by the training image (block 520). The method further comprises training a plurality of local Convolutional Neural Networks (CNNs) of the computer vision model in parallel (block 530). The training comprises, for each of the local CNNs, predicting the health test result depicted in a respective one of the segments of each training image based on local features extracted by the local CNN from the respective one of the segments of the training image and global features extracted by a global CNN of the computer vision model from the test membrane of the training image.

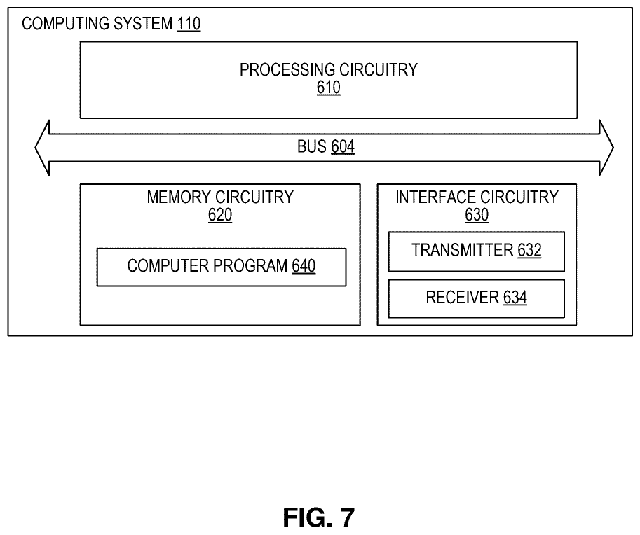

Other embodiments of the present disclosure include a computing system 110, e.g., as illustrated in the example of FIG. 7. The computing system 110 comprises processing circuitry 610, memory circuitry 620, and interface circuitry 630 that are communicatively coupled to each other, e.g., via one or more buses 604. The computing system 110 may be organized into any number of individual computing devices that may be configured to communicate with each other, e.g., by exchanging signals via the interface circuity 630. In some embodiments, the computing system 110 comprises a single computing device. In other embodiments, the computing system 110 comprises a plurality of computing devices (e.g., one or more server devices for training a computer vision model and one or more user devices for obtaining training images).

The processing circuitry 610 may comprise one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. For example, the processing circuitry 610 may be programmable hardware capable of executing software instructions stored, e.g., as a machine-readable computer program 640 in the memory circuitry 620.

The memory circuitry 620 of the various embodiments may comprise any non-transitory machine-readable media known in the art or that may be developed, whether volatile or non-volatile, including but not limited to solid state media (e.g., SRAM, DRAM, DDRAM, ROM, PROM, EPROM, flash memory, solid state drive, etc.), removable storage devices (e.g., Secure Digital (SD) card, miniSD card, microSD card, memory stick, thumb-drive, USB flash drive, ROM cartridge, Universal Media Disc), fixed drive (e.g., magnetic hard disk drive), or the like, wholly or in any combination.

The interface circuitry 630 may be a controller hub configured to control the input and output (I/O) data paths of the computing system 110. Such I/O data paths may include data paths for exchanging signals over a communications network. Such I/O data paths may additionally or alternatively include data paths for exchanging signals with one or more I/O devices for purposes of interacting with a user. For example, the interface circuitry 630 may comprise a transceiver configured to send and receive communication signals over a network. The interface circuitry 630 may additionally or alternatively comprise a graphics adapter, a display port, a video bus, a touchscreen, a graphical processing unit (GPU), a display, or any combination thereof for presenting visual information to a user. The interface circuitry 630 may additionally or alternatively comprise a pointing device (e.g., a mouse, stylus, touchpad, trackball, pointing stick, joystick), touchscreen, microphone configured to respond to speech input, optical sensor configured to optically recognize gestures, a keyboard, or any combination thereof.

The interface circuitry 630 may be implemented as a unitary physical component, or as a plurality of physical components that are contiguously or separately arranged, any of which may be communicatively coupled to any other or may communicate with any other via the processing circuitry 610. For example, the interface circuitry 630 may comprise a transmitter 632 configured to send communication signals over a network and a receiver 634 configured to receive communication signals over the network. Other examples, permutations, and arrangements of the above and their equivalents will be readily apparent to those of ordinary skill.

The computing system 110 may be configured to perform the method 500 illustrated in FIG. 6, e.g., through operations performed by the processing circuitry 610. In one example, the processing circuitry 610 is configured to obtain a plurality of training images. Each training image depicts a plurality of health test results in respective segments of a test membrane of a health test kit. The processing circuitry 610 is configured to obtain, for each training image, labeling indicating the health test results depicted by the training image. The processing circuitry 610 is configured to train a plurality of local Convolutional Neural Networks (CNNs) of the computer vision model in parallel, wherein the training comprises, for each of the local CNNs. Predicting the health test result depicted in a respective one of the segments of each training image based on local features extracted by the local CNN from the respective one of the segments of the training image and global features extracted by a global CNN of the computer vision model from the test membrane of the training image.

In some embodiments, the computer program 640 stored in the memory circuitry 620 controls the computing system 110. In this regard, the computer program 640 may comprise software instructions that, when executed by the processing circuitry 610, cause the computing system to carry out the method 500 discussed above.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein. Although steps of various processes or methods described herein may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention.

What is claimed is:

1. A method, implemented by a computing system, of training a computer vision model to classify health test kit results, the method comprising:
obtaining a plurality of training images, wherein each training image depicts a plurality of health test results in respective segments of a test membrane of a health test kit;
obtaining, for each training image, labeling indicating the health test results depicted by the training image;
training a plurality of local Convolutional Neural Networks (CNNs) of the computer vision model in parallel, wherein the training comprises, for each of the local CNNs, predicting the health test result depicted in a respective one of the segments of each training image based on:
local features extracted by the local CNN from the respective one of the segments of the training image; and
global features extracted by a global CNN of the computer vision model from the test membrane of the training image.

2. The method of claim 1, wherein training the plurality of local CNNs comprises, for each of the training images:
generating, by the global CNN, a global feature map indicating the global features extracted from the training image; and
for each segment of the test membrane of the training image, using the local CNN corresponding to the segment to:
generate a local feature map indicating the local features extracted from the segment;
generate a combined feature map by combining the local feature map with the global feature map;
extract combined features from the combined feature map; and
generate a revised local feature map indicating the combined features extracted from the combined feature map, wherein predicting the health test result depicted in the segment based on the local features and the global features comprises using the revised local feature map to generate a prediction based on the combined features.

3. The method of claim 2, wherein training the plurality of local CNNs further comprises, for each of the training images, applying a loss function to determine an amount of error between the predictions of the heath test results depicted in the segments of the training image and the labeling of the training image.

4. The method of claim 3, wherein:
using the local CNN of each segment to generate the prediction of the health test result depicted in the segment comprises using a binary classifier of the local CNN to generate the prediction; and
training the plurality of local CNNs further comprises adjusting each of the binary classifiers to reduce the amount of error using a gradient calculated by backpropagating the loss function.

5. The method of claim 4, wherein:
the loss function comprises a cross-entropy loss function;
backpropagating the loss function comprises adjusting weights applied by each of the binary classifiers to generate the predictions.

6. The method of claim 1, further comprising:
obtaining a non-training image depicting a plurality of actual health test results in the respective segments of the test membrane of the health test kit; and
using the global CNN and the trained local CNNs of the computer vision model to determine whether each of the actual health test results indicates a positive or negative result.

7. The method of claim 6, further comprising further training at least one of the local CNNs responsive to receiving result labels indicating each of the actual health test results depicted by the non-training image.

8. The method of claim 1, further comprising detecting the segments of each training image, wherein the segments of each training image are arranged in a single row.

9. The method of claim 1, further comprising detecting the segments of each training image, wherein the segments of each training image are arranged in a two-dimensional grid.

10. A computing system comprising:
processing circuitry and memory circuitry, the memory circuitry storing instructions executable by the processing circuitry whereby the computing system is configured to:
obtain a plurality of training images, wherein each training image depicts a plurality of health test results in respective segments of a test membrane of a health test kit;
obtain, for each training image, labeling indicating the health test results depicted by the training image;
train a plurality of local Convolutional Neural Networks (CNNs) of the computer vision model in parallel;
wherein to train the plurality of local CNNs the computing system is configured to predict, for each of the local CNNs, the health test result depicted in a respective one of the segments of each training image based on:
local features extracted by the local CNN from the respective one of the segments of the training image; and
global features extracted by a global CNN of the computer vision model from the test membrane of the training image.

11. The computing system of claim 10, wherein to train the plurality of local CNNs the computing system is configured to, for each of the training images:
use the global CNN to generate a global feature map indicating the global features extracted from the training image; and
for each segment of the test membrane of the training image, use the local CNN corresponding to the segment to:
generate a local feature map indicating the local features extracted from the segment;
generate a combined feature map by combining the local feature map with the global feature map;
extract combined features from the combined feature map; and
generate a revised local feature map indicating the combined features extracted from the combined feature map;
wherein to predict the health test result depicted in the segment based on the local features and the global features the computing system is configured to use the revised local feature map to generate a prediction based on the combined features.

12. The computing system of claim 11, wherein to train the plurality of local CNNs the computing system is further configured to, for each of the training images, apply a loss function to determine an amount of error between the predictions of the heath test results depicted in the segments of the training image and the labeling of the training image.

13. The computing system of claim 12, wherein:
to use the local CNN of each segment to generate the prediction of the health test result depicted in the segment the computing system is configured to use a binary classifier of the local CNN to generate the prediction; and
to train the plurality of local CNNs the computing system is further configured to adjust each of the binary classifiers to reduce the amount of error using a gradient calculated by backpropagating the loss function.

14. The computing system of claim 13, wherein:
the loss function comprises a cross-entropy loss function;
to backpropagate the loss function the computing system is configured to adjust weights applied by each of the binary classifiers to generate the predictions.

15. The computing system of claim 10, further configured to:
obtain a non-training image depicting a plurality of actual health test results in the respective segments of the test membrane of the health test kit; and
use the global CNN and the trained local CNNs of the computer vision model to determine whether each of the actual health test results indicates a positive or negative result.

16. The computing system of claim 15, further configured to train at least one of the local CNNs responsive to receiving result labels indicating each of the actual health test results depicted by the non-training image.

17. The computing system of claim 10, further configured to detect the segments of each training image, wherein the segments of each training image are arranged in a single row.

18. The computing system of claim 10, further configured to detect the segments of each training image, wherein the segments of each training image are arranged in a two-dimensional grid.

19. A non-transitory computer readable medium storing software instructions for controlling a programmable computing system to train a computer vision model, wherein the software instructions, when executed by processing circuitry of the programmable computing system, cause the programmable computing system to:
obtain a plurality of training images, wherein each training image depicts a plurality of health test results in respective segments of a test membrane of a health test kit;
obtain, for each training image, labeling indicating the health test results depicted by the training image;
train a plurality of local Convolutional Neural Networks (CNNs) of the computer vision model in parallel, wherein the training comprises, for each of the local CNNs, predicting the health test result depicted in a respective one of the segments of each training image based on:
local features extracted by the local CNN from the respective one of the segments of the training image; and
global features extracted by a global CNN of the computer vision model from the test membrane of the training image.
